(19) United States
(12) Patent Application Publication
(10) Pub. No.: US 2015/0331510 A1
(43) Pub. Date: Nov. 19, 2015

(54) Touch Control Assembly, Device Control Method, Controller and Electronic Equipment

(71) Applicant: XIAOMI INC., Beijing (CN)

(72) Inventors: Chuan WANG, Beijing (CN); Chuangqi LI, I, Beijing (CN); Fa WANG, Beijing (CN); Hui WANG, Beijing (CN)

(73) Assignee: XIAOMI INC., Beijing (CN)

(21) Appl. No.: 14/622,481

(22) Filed: Feb. 13, 2015

Related U.S. Application Data
(63) Continuation-in-part of application No. PCT/CN2014/089277, filed on Oct. 23, 2014.

(30) Foreign Application Priority Data
May 13, 2014 (CN) 201410200756.0

(51) Int. Cl. G06F 3/041; G06F 3/0488

(52) U.S. Cl. CPC G06F 3/041; G06F 3/04883

(57) ABSTRACT

The disclosure provides a touch control assembly, a method for controlling a device, a controller and an electronic device. The touch control assembly comprises: a touch pad and a controller. The touch pad is configured to detect a touch control operation on the touch pad, and send a touch control signal corresponding to the touch control operation to the controller. The controller is configured to analyze and determine the touch control operation according to the touch control signal, and control the electronic device according to the touch control operation and the operation state of the electronic device.

### PRIORITY STATEMENT

This application is a Continuation-in-part Application of International Application No. PCT/CN2014/089277, filed on Oct. 23, 2014, which is based upon and claims priority of Chinese Patent Application No. 201410200756.0, filed on May 13, 2014, the entire contents of which are incorporated herein by reference.

### TECHNICAL FIELD

The present disclosure relates to the field of equipment control. Specifically, the present disclosure relates to a touch control assembly, a method for controlling a device, a controller and an electronic device.

### BACKGROUND

With fast development of electronic technologies, intelligent electronic devices are becoming more and more popular. Oftentimes a user of an electronic device conducts certain control over his/her electronic device, For example to adjust volume, to obtain a preferred user experience during usage of the electronic device.

Normally a large electronic device includes a remote control or physical keys arranged in the electronic device for a user to conduct control over it. Taking television (TV) as an example, a TV may be equipped with a remote control. A user may be able to conduct most of operations available to the TV on the remote control. When the remote control for the TV is lost or destroyed, the user may also control the TV by several physical keys arranged on the TV. For example, a TV is typically equipped with 6 physical keys. They are a power key, a menu key, a volume + key, a volume − key, a channel + key, and a channel − key. The user may control the TV by these 6 physical keys when the remote control is not available.

### SUMMARY

According to an aspect of the present disclosure, a touch control assembly for controlling a television may comprise a touch pad to detect a touch control operation thereon; and a controller in the television in communication with the touch pad. The controller may be configured to receive from the touch pad a touch control signal corresponding to the touch control operation, determine the touch control operation based on the touch control signal, obtain an operation state of the television, and control the television according to the touch control operation and the operation state of the television.

According to another aspect of the present disclosure, a method for controlling a television may comprise providing a television comprising a controller, the controller is configured to communicate with a touch pad; receiving, by a controller, a touch control signal corresponding to a touch control operation conducted on the touch pad; determining, by the controller, the touch control operation based on the touch control signal; obtaining, by the controller, an operation state of the television; and controlling, by the controller, the television according to the touch control operation and the operation state of the television.

According to another aspect of the present disclosure, a television may comprise a touch sensing area on a surface of the television to detect a touch control operation on the touch sensing area; and a controller in the television in communication with the touch sensing area. The controller may be configured to receive from the touch sensing area a touch control signal corresponding to the touch control operation, determine the touch control operation based on the touch control signal, obtain an operation state of the television, and direct the television to conduct an operation according to the touch control operation and the operation state.

According to yet another aspect of the present disclosure, a non-transitory computer-readable storage medium may have stored therein instructions, when executed by one or more processors of a mobile device, causes the mobile device to perform a method for controlling a device for use in the touch control assembly, the touch control assembly may be for use in the electronic device, and the method may comprise receiving a touch control signal sent from the touch control assembly and corresponding to a touch control operation on the touch pad; analyzing and interpreting the touch control operation according to the touch control signal; obtaining a operation state of the electronic device; and controlling the electronic device according to the touch control operation and the operation state of the electronic device.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a block diagram illustrating a touch control assembly according to an example embodiment;

FIG. 2 is a block diagram illustrating a touch control assembly according to another example embodiment;

FIG. 3 is a diagram showing a configuration of a touch pad according to another example embodiment;

FIG. 4 is a block diagram illustrating a touch control assembly according to a further example embodiment;

FIG. 5 is a diagram showing that a user is waking up an electronic device according to a further example embodiment;

FIG. 6 is a diagram showing that the user is turning off an electronic device according to a further example embodiment;

FIG. 7 is a diagram displaying a control interface according to a further example embodiment;

FIG. 8 is a diagram showing the function switching according to a further example embodiment;

FIG. 9 is a diagram showing a secondary menu according to a further example embodiment;

FIG. 10 is a flow chart of a method for controlling a device according to an example embodiment;

FIG. 11 is a flow chart of a method for controlling a device according to another example embodiment;

FIG. 12 is a block diagram illustrating a controller according to an example embodiment;

FIG. 13 is a block diagram illustrating a controller according to another example embodiment;

FIG. 14 is a block diagram illustrating an electronic device according to an example embodiment;

FIG. 15 is a schematic diagram illustrating an example embodiment of an electronic device;

FIG. 16 illustrates an example touch pad that may be implemented in the electronic device.

### DETAILED DESCRIPTION

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the invention. Instead, they are merely examples of apparatuses and methods consistent with aspects related to the invention as recited in the appended claims.

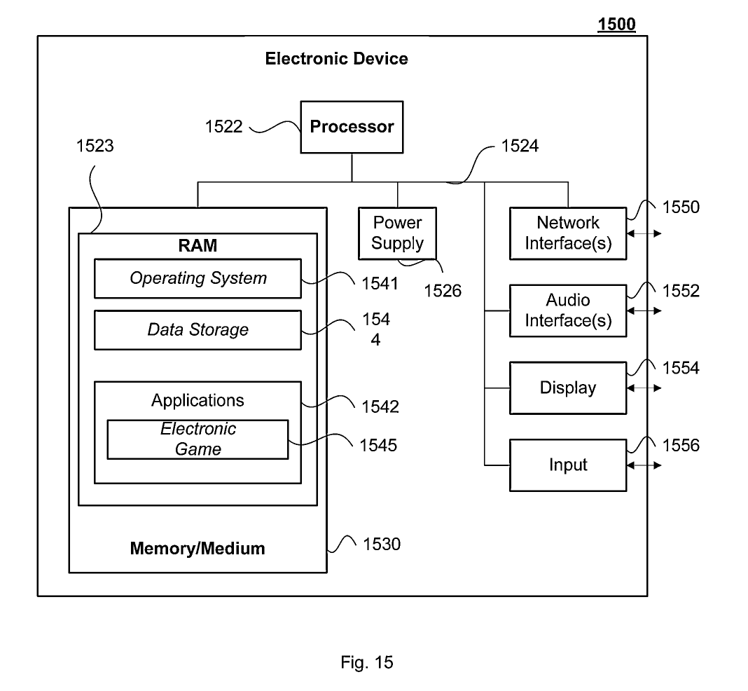

FIG. 15 is a schematic diagram illustrating an example embodiment of an electronic device 1500 in the present disclosure. The electronic device may include apparatuses to execute methods and/or software systems introduced in the present disclosure. The electronic device 1500 may be a computing device capable of executing a software system. The electronic device 1500 may, for example, be a device such as a TV, a computer monitor, a video projector, or other type of intelligent electronic devices.

The electronic device 1500 may vary in terms of capabilities or features. Claimed subject matter may be intended to cover a wide range of potential variations. For example, the electronic device 1500 may include one or more input interface 1556, such as physical keys, a remote control, or a local touch pad, to input instructions to the electronic device 1500. It may also include a display 1554, such as a liquid crystal display (LCD), or a display with a high degree of functionality, such as a touch-sensitive color 2D or 3D display.

The electronic device 1500 may be web-enabled. The electronic device 1500 may include a network interface 1550. The network interface may be an antenna configured to receive communication signal from and/or send communication signal to a satellite TV channel and/or a mobile terminal, and/or a TV service server; a cable interface configured to receive cable TV signal and/or send communication signal to a server connected to the TV cable; and/or a network interface receive from and/or send signals to a network, such as Internet.

The electronic device 1500 may also include or may execute a variety of operating systems 1541, including an operating system. The electronic device 1500 may include or may execute a variety of possible applications 1542, such as an electronic game 1545. The application 1542 may enable communication with other devices via a network, such as communicating with a computer device or server via a network for online content browsing or video streaming.

Further, the electronic device 1500 may include one or more non-transitory processor-readable storage media 1530 and one or more processors 1522 in communication with the non-transitory processor-readable storage media 1530. For example, the non-transitory processor-readable storage media 1530 may be a RAM memory, flash memory, ROM memory, EPROM memory, EEPROM memory, registers, hard disk, a removable disk, or any other form of non-transitory storage medium known in the art. The one or more non-transitory processor-readable storage media 1530 may store sets of instructions, or units and/or modules that include the sets of instructions, for conducting operations and/or method steps described in the present disclosure. Alternatively, the units and/or modules may be hardware disposed in the electronic device 1500 configured to conduct operations and/or method steps described in the present disclosure. The one or more processors may be configured to execute the sets of instructions and perform the methods and/or operations in example embodiments of the present disclosure.

Merely for illustration, only one processor will be described in electronic devices that execute operations and/or method steps in the following example embodiments. However, it should be note that the electronic devices in the present disclosure may also include multiple processors, thus operations and/or method steps that are performed by one processor as described in the present disclosure may also be jointly or separately performed by the multiple processors. For example, if in the present disclosure a processor of an electronic device executes both step A and step B, it should be understood that step A and step B may also be performed by two different processors jointly or separately in the electronic device (e.g., the first processor executes step A and the second processor executes step B, or the first and second processors jointly execute steps A and B).

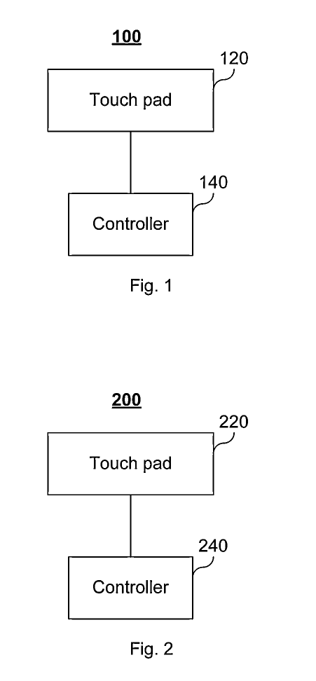

FIG. 1 is a block diagram illustrating a touch control assembly 100 according to an example embodiment. The touch control assembly 100 may be part of the electronic device 1500, which may be a TV, a monitor, or a video projector. For example, the touch control assembly 100 may be the input 1556 of the electronic device 1500 or may be incorporated into the display 1554 of the electronic device 1500. The touch control assembly may comprise: a touch pad 120 and a controller 140. It may be configured to adjust parameters of the electronic device 1500, such as brightness of the display 1554, volume of the electronic device 1500.

The touch pad 120 may be configured to detect a touch control operation on the touch pad 120, and send a touch control signal corresponding to the touch control operation to the controller 140. The touch pad 120 may be arranged outside of the display 1554 of the electronic device, such as, at the bottom of the electronic device 1500. Alternatively, the touch pad 120 may be incorporated into and be part of the display 1554.

The controller 140 may be configured to receive the touch control signal from the touch pad 120, analyze and interpret the touch control operation according to the touch control signal, obtain operation state of the electronic device, and control the electronic device according to the touch control operation and the operation state of the electronic device.

In conclusion, the touch control assembly shown by the example embodiment detects and/or determines the touch control operation on the touch pad by the controller according to the touch control signal sent by the touch pad, perform to control the electronic device according to the touch control operation and the operation state of the electronic device, so that the user may accomplish control of the electronic device by conducting different operations in the touch pad without looking for and pressing different physical keys. The problem that the user may easily make wrong operations when using the physical keys in related technology may be solved, resulting in simplification of user operation and improve user experience.

FIG. 2 is a block diagram illustrating a touch control assembly 200 according to another example embodiment. The touch control assembly 200 may be part of the electronic device 1500, which may be a TV, a monitor, or a video projector. For example, the touch control assembly 200 may be the input 1556 of the electronic device 1500 or may be incorporated into the display 1554 of the electronic device 1500. The touch control assembly may comprise: a touch pad 220 and a controller 240. It may be configured to adjust parameters of the electronic device 1500, such as brightness of the display 1554, volume of the electronic device 1500.

The touch pad 220 may be configured to detect a touch control operation on the touch pad 220, and send a touch control signal corresponding to the touch control operation to the controller 240; Alternatively, the touch pad 220 may be incorporated into and be part of the display 1554.

The touch pad may be a sensing system adopting variety types of designs. For example, the touch pad 220 may include a resistive film touch panel, a capacitive touch panel, a surface capacitive touch panel, a projected capacitive touch panel, a surface acoustic wave (SAW) touch panel, an optical touch panel, an electrostatic induction touch panel, or a combination thereof. For example, when the touch pad 220 includes in the electrostatic induction touch panel, the touch pad 220 may include several touch control points. Electrostatic induction occurs when the user touches the touch control point in the touch pad by the finger. A current sensing signal may be generated by the electrostatic induction. The touch pad may generate a corresponding touch control signal according to the generated current sensing signal and may send the touch control signal to the controller. The touch control signal may contain an identification of the touch control point of the user's current touching location. For example, the identification of the touch control point may be the coordinate or the serial number of the touch control point on the touch pad.

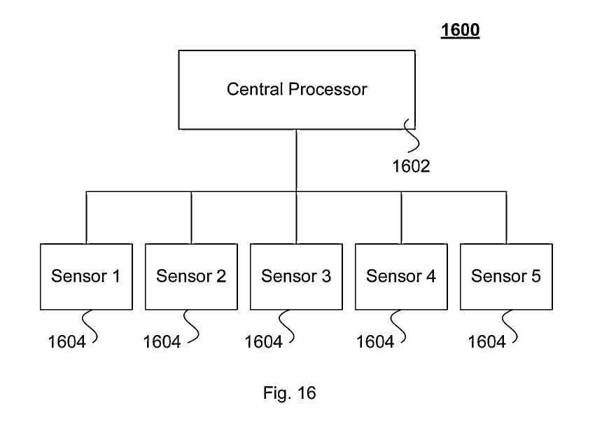

FIG. 16 illustrates another example touch pad 1600 that may be implemented in the electronic device 1500. The touch pad 1600 may include a central processor 1602 and a plurality of sensors 1604. FIG. 16 illustrates a design of a touch pad 1600 with only five sensors. It should be understand that the touch pad 1600 may include any number of sensors.

The two sensors 1604 may be any sensors to sense any electrical conductor around the two sensors 1604. For example, the two sensors 1604 may be capacity transducers. When an object, such as a user's hand, appears around the sensors, the electrical resistance of the object may cause capacity changes of the sensors. For example, when the object is closer to sensor 1 than sensor 2, sensor 1 may have a bigger capacity change than sensor 2.

The central processor 1602 may be electronically connected to the sensors 1604 and may sample the capacities of the two sensors 1604 with a predetermined frequency and detect any change in the capacities. Based on the amplitude of the capacity and changes of the capacity during two sampling signal, the central processor 1602 may calculate the position of the object as well as the speed and direction that the object moves. Note that the direction being detected may be based on the way that the sensors 1604 are laid out. For example, if the sensors 1604 are laid out along a line, the touch pad 1600 may only detect movement of the object along that line. If the sensors 1604 are laid out as a two-dimensional array, the touch pad 1600 may be able to detect two-dimensional movement of the object.

When the central processor 1602 detects a movement of the object (e.g., the user's hand) near the sensors 1604 through the sampling and processing of capacity data of the sensors 1604, the central processor 1602 may send an alert signal to inform the electronic device 1500 the movement of the object. The electronic device 1500 may sample and/or receive the movement data from the central processor 1602, either upon receiving the alert signal from the central processor 1602 or by actively doing so without receiving the alert signal. The electronic device 1500 may determine the movement (e.g., position, direction, velocity) of the object through the movement information and display the movement on it screen. For example, when a user is trying to conduct a particular operation on the electronic device 1500, the electronic device 1500 may display a plurality of operation icons on its screen along a line. The user may slide his/her fingers to left in order to select an operation icon. The electronic device 1500 may detect the sliding operation through the sensors 1604 and display an animation on the screen to visually show that the user is switching his/her selection towards left.

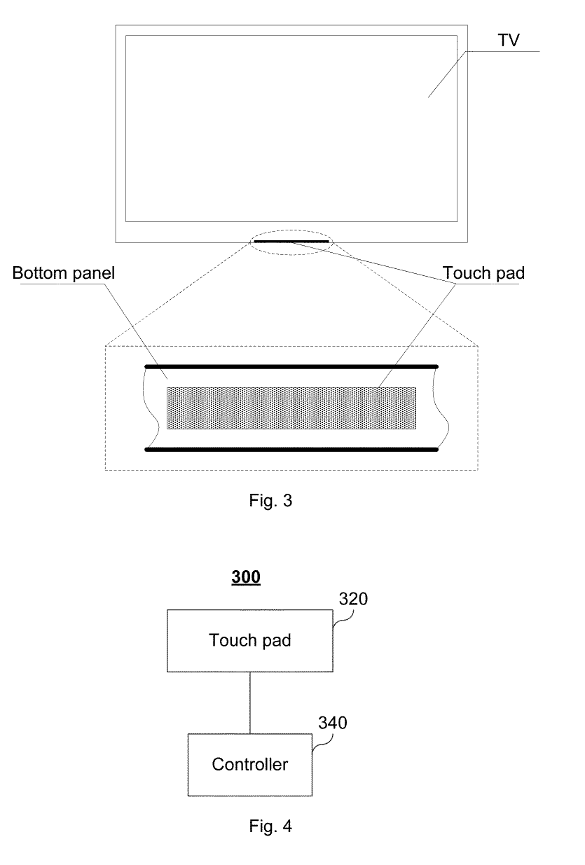

Taking TV as an example of the electronic device 1500, FIG. 3 is a diagram showing a configuration of a touch pad. The functions of the TV may be designed so that a user may be able to control the TV by tapping his/her fingers and sliding his/her fingers towards left or right on the touch pad. Accordingly, the sensors in the touch pad may be arranged so that it only sense movement of a user's hand along a line of left and right.

In FIG. 3, the touch pad is arranged in the middle position at the bottom of the TV. But it should be note that the touch pad may also be arranged on other portions of the TV or be designed as an independent device that is capable to communicate with the controller 240 wirelessly.

The controller 240 may be configured to receive the touch control signal, analyze and interpret the touch control operation according to the touch control signal, obtain operation state of the electronic device, and control the electronic device according to the touch control operation and the operation state (e.g., status of operation) of the electronic device.

For example, the controller 240 may analyze and interpret the user's touch control operation on the touch pad according to the time when the touch control signal is received and the position that the user touches the touch pad 220, i.e., the identification of the touch control point contained in the touch control signal. The touch control operation may be click operation, long press operation or slide operation, etc. The controller may carry out operation such as wake-up, standby, menu selection and control instruction according to the touch control operation and the operation state of the electronic device 1500.

For example, the long press operation may be a first operation. When the electronic device 1500 is in standby mode, and the touch control operation is a first operation, the controller 240 may control to wake up and/or reactivate the electronic device 1500. For example, when the electronic device 1500 is a TV powered on and in the standby mode, if the controller detects a long press operation on the touch pad, the controller 240 may wake up or reactivate the TV.

The long press operation may also be a second operation. When the electronic device 1500 is in a waked-up mode, and the touch control operation is the second operation, the controller 240 may control the electronic device to turn to standby mode. For example, when the electronic device 1500 is a TV powered on and in a waked-up mode, the controller 240 may turn the TV to the standby mode if the controller 240 detects a long press operation on the touch pad according to the touch control signal sent by the touch pad.

The slide operation may be a third operation. When the electronic device is in the waked-up mode and displays a control interface, and the touch control operation is the third operation, the controller 240 may control the electronic device to select and display an icon in the control interface corresponding to a function selected by the user through the touch pad 220. Here, the control interface may include the icon (or a plurality of icons); and the icon may correspond to at least one function. For example, the control interface of the TV may display one or more icons, and each icon may correspond to one function. These functions may include, but are not limited to, a searching remote control function, a volume adjustment function, a channel selection function, an input source switching function, a 3D mode control function, and a brightness adjustment function, etc. The user may operate on the touch pad to instruct and/or control the TV to display the control interface with the icons. When the user slides his/her finger though the touch pad 220 to select an icon (thus the function corresponding to the icon) or change the icon selection from one icon to another, the controller 240 may detect the slide operation and the corresponding selection operation from the user. The controller 240 then may control the TV to display the selection on the interface. For example, when the user slide his/her finger on the touch pad to switch from a channel selection function to a function of switching input sources, the controller 240 may control the TV to display the switch from the channel selection icon to the input source switch icon on the control interface.

Because each function has a corresponding icon displayed on the control interface, visually the user may select an icon on the control interface when the user selects a function of the electronic device 1500 to operate. The selected function and the unselected function may be distinguished by the display effect. For example, the electronic device may display a bigger image (or make the image the biggest) to the icon corresponding to the selected function, or may display a colorful image to the icon corresponding to the selected function while display icons corresponding to the unselected functions black and white, or display the icon corresponding to the selected function with highlight, etc.

When the controller 240 switches to and selects the icon corresponding to the selected function on the control interface, it may also obtain the sliding direction of the slide operation, and switch to and/or select the icon corresponding to the selected function according to the sliding direction. For example, the icons of respective functions of the control interface of the TV may be arranged in a predetermined order. When the controller 240 detects and/or determines that the user slides towards right on the touch pad, it may switch from a present icon to an icon corresponding to a previous function in the predetermined order. When the controller 240 detects and determines that the user slides toward left on the touch pad, it may switch from the present icon to an icon corresponding to a next function in the predetermined order.

The controller 240 may determine the sliding direction of the slide operation according to a sequence of touch control points the slide operation slides through. For example, the touch pad 220 may include a plurality of touch control points (sensors or sensitive points that may detect a touch on a corresponding position of the touch pad). The plurality of touch control points may be arranged as an array or a matrix on the touch pad 220. The corresponding position information of each touch control point on the touch pad may be saved in a storage medium of the electronic device 1500 and assessable by the controller 240. Further, each touch control point may have a preset identification, such as a preset serial number. Accordingly, when the user touches a position on the touch pad that corresponds with a touch control point, the touch control point may sense the touch and send a signal to the controller 240. The signal may include the identification of the touch control point so that the controller 240, upon receiving the signal, may retrieve the identification of the touch control point and may identify which touch control point is touched (i.e., activated). Using the position information of each touch control point, the controller 240 may determine the position on the touch pad 220 that is touched by the user. Thus, when the user slides through the touch pad 220 alone a path, the slide operation may activate a series of touch control points on the path. The controller 240 may detect a time sequence and a position sequence of the series of touch control points on the touch pad 220. The controller 240 may determine the direction or even a sliding speed of the slide operation based on the time sequence and position sequence of the activated touch control points. The controller 240 may control the electronic device 1500 to display the switch of icons based on the sliding speed the slide operation.

The click operation may be a fourth operation. When the electronic device is in the waked-up mode and displays the control interface, and the touch control operation on the touch pad 220 is the fourth operation, the fourth operation may instruct the controller 240 to execute a function corresponding to the selected icon on the control interface. For example, when the selected function corresponds to a secondary menu, the controller 240 may send a control instruction to the electronic device 1500 to open the secondary menu and display the secondary menu of the selected function; when the selected function does not correspond to the secondary menu, the controller 240 may send a control instruction to the electronic device 1500 to execute to the selected function.

The fourth operation may be a click operation, a tap operation, or a double tap or click operation. When the TV displays the control interface and the controller 240 detects that click operation to the touch pad 220, the controller 240 may send a control instruction to the TV to operate a selected function before the click operation. For example, if the user selected an icon of searching a remote control, and the search remote control function does not correspond to the secondary menu, the controller may control the TV to send wireless signal to the remote control. The remote control may respond with a ringing tone to notify the user of its location after the remote control receives the wireless signal; or when the currently selected function icon is the input source switching function, and the function corresponds to the input source selection menu, a secondary menu, the controller may control the TV to display the input source selection menu. The input source selection menu may contain optional icons of multiple input sources, so that the user may select an icon by sliding in the touch pad left and right, and determine the input source corresponding to one selection item by the click operation.

In conclusion, the touch control assembly shown in the example embodiment detects and/or determines the touch control operation on the touch pad by the signals sent by the touch pad, controls the electronic device according to the operation state of the touch control operation and the electronic device. The user may control the electronic device according to different operations in the touch pad without seeking and pressing different physical keys. The problem of related technology that the user may easily make wrong operation when using the physical keys may be solved, resulting in simplification of user operation and improved user experience.

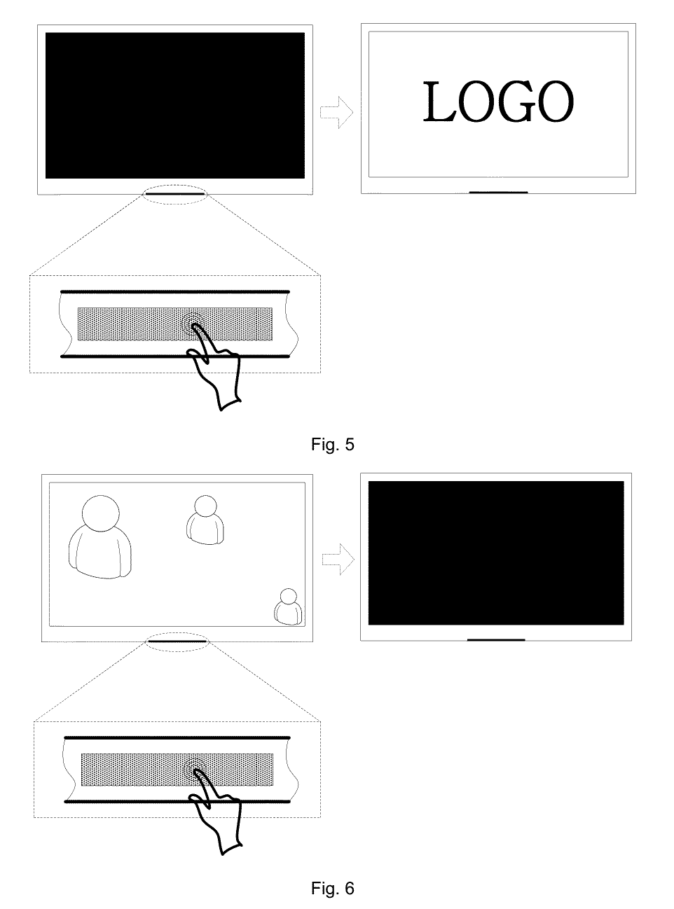

FIG. 4 is a block diagram illustrating a touch control assembly 300 according to a further example embodiment. The touch control assembly 300 may be part of the electronic device 1500, which may be a TV, a monitor, or a video projector. For example, the touch control assembly 300 may be the input 1556 of the electronic device 1500 or may be incorporated into the display 1554 of the electronic device 1500. The touch control assembly may include a touch pad 320 and a controller 340. It may be configured to adjust parameters of the electronic device 1500, such as brightness of the display 1554, volume of the electronic device 1500.

The touch pad 320 may be configured to detect the touch control operation on the touch pad 320 and send the touch control signal corresponding to the touch control operation to the controller 340. The touch pad 320 may have the same design or structure as the touch pad 220. For example, the touch pad 320 may include several touch control points. When the user's finger touches the touch control point in the touch pad 320, electrostatic induction occurs, and current sensing signals are generated. The touch pad 320 may produce a corresponding touch control signal and send it to the controller 340 according to the generated sensing current signal. The touch control signal may include an identification of the touch control point of the user's current touching position. For example, the identification of the touch control point may be the coordinates of the touch control point or the serial number of the touch control point.

Taking TV as an example of the electronic device 1500, referring to FIG. 3 which is a diagram showing a configuration of a touch pad, the touch pad may be arranged right in the middle position at the bottom of the TV. But it should be note that the touch pad may also be arranged on other portions of the TV or be designed as an independent device that is capable to communicate with the controller 240 wirelessly.

The controller 340 may be configured to receive the touch control signal, analyze and interpret the touch control operation according to the touch control signal, obtain an operation state of the electronic device, and control the electronic device according to the touch control operation and the operation state of the electronic device.

Wherein, the controller 340 may detect the user's touch control operation on the touch pad 320 according to the time when the touch control signal is received and the identification of the touch control point contained in the touch control signal. The touch control operation may be click operation, long press operation or slide operation, etc. The controller 340 may control the electronic device 1500 to conduct operations such as wake-up, standby, menu selection, and control instruction according to the touch control operation and the operation state of the electronic device. Taking an intelligent TV as one example of the electronic device 1500, the controller may be a central processing unit in the intelligent TV, such as a processor.

The controller 340 may be configured to control the electronic device 1500 to wake up when the electronic device is in standby mode, and the touch control operation may be a first operation.

The first operation may be a long press operation. Taking the TV for example, the controller 340 may wake up the TV when the TV is powered on and in the standby mode, if the controller detects and/or determines that the user is conducting a long press operation on the touch pad according to the touch control signal sent by the touch pad 320.

FIG. 5 is a diagram showing that the user is waking up an electronic device 1500, such as a TV. When the TV is in the standby mode, there is no image on its display. Thus the display is black. The controller 340 may wake up the TV when it detects and/or determines that the user's finger keeps touching on the touch pad for over 3 s (three seconds). When the TV is waked up, it starts to display videos or images, such as the “LOGO” in FIG. 5.

The controller 340 may be configured to turn the electronic device 1500 to the standby mode when the electronic device 1500 is in the waked-up mode, and the touch control operation is a second operation.

The second operation may also be a long press operation. The controller 340 may turn the TV from the active mode to the standby mode if the controller 340 detects and/or determines that the user is conducting a long press operation on the touch pad 320 according to the touch control signal sent by the touch pad 320.

For example, FIG. 6 is a diagram showing that the user is turning off an electronic device or turning the electronic device to the standby mode. When the TV is in the waked-up mode, there are images and/or video on its display. The controller 340 may turn off the TV (i.e., turns the TV to the standby mode) when it detects and/or determines that the user's finger keeps touching on the touch pad for over 3 s. Accordingly, the display of the TV turns black.

The controller 340 may be configured to switch to an icon (i.e., switch from an old icon to the icon and select the icon) corresponding to a selected function in the control interface when the electronic device may be in the waked-up mode and displays the control interface, and the touch control operation may be a third operation; the control interface may include the icon corresponding to at least one function.

The third operation may be slide operation. For example, the control interface of the TV may display one or more icons, and each icon corresponds to one function. These functions may include searching a remote control function, a volume adjustment function, a channel selection function, an input source switching function, a 3D mode control function and a brightness adjustment function, etc. When the TV displays the control interface and if the controller 340 detects and/or determines that the user's operation on the touch pad is a slide operation, the controller 340 may switch the icon of the selected function in the current displayed control interface. For example, switch the channel selection function to the input source switching function.

The icon corresponding to the function displayed on the control interface may include one icon corresponding to the selected function. The selected function and the unselected function may be distinguished by the display effect. For example, the selected function may have a bigger (or the biggest) size, or the selected function may correspond to colorful icon while unselected function corresponds to black and white ones, or the selected function may be displayed with highlight, etc.

When the controller 340 is switching and/or selecting the icon corresponding to the selected function in the control interface, it may also obtain the sliding direction of the slide operation, and switch the icon corresponding to the selected function according to the sliding direction. For example, the icons of respective functions of the control interface of the TV may be arranged in a predetermined order. When the controller detects and/or determines that the user's operation on the touch pad may be a slide operation toward right, it may switch the icon of the selected function of the control interface to be the icon of the previous function. When the controller 340 detects and/or determines that the user's operation on the touch pad is a slide operation toward left, it may switch the icon of the selected function of the control interface to be the icon of the next function.

The sliding direction of the slide operation may be determined according the sequence of the touch control points in the slide operation. For example, the controller 340 may obtain a preset serial number for each touch control point on the touch pad 320 in advance. When the user's finger touches one point by sliding, the touch pad 320 may send the touch control signal which may carry the serial number of the touch control point to the controller 320. The controller 320 may determine the sliding direction according to the serial numbers of the touch control points contained in the successively received touch control signals.

The controller 340 may be configured to obtain the GUI (Graphical User Interface) display status of the electronic device 1500, when the electronic device is in the waked-up mode and does not display the control interface. The controller 340 may determine a list of functions (a function list) that corresponds to the control interface according to the GUI display status, and display a corresponding icon of at least one function according to the function list; the at least one function may be all or portion of the functions contained in the function list.

For example, if the electronic device 1500 is a TV, the TV may have different GUI display statuses, such as the digital TV program interface display mode, the on demand interface display mode, the network interface display mode, or the game interface display mode, etc. The functions contained in the control interface corresponding to different display modes may be different. When the TV displays the control interface, for example, when the TV is on and does not display the control interface, if the controller 340 detects and/or determines a click operation on the touch pad 320 from the user, it may first determine the TV's current display mode, and determine the corresponding function list according to the display mode, then display the control interface and the corresponding icon of at least one function according to the function list.

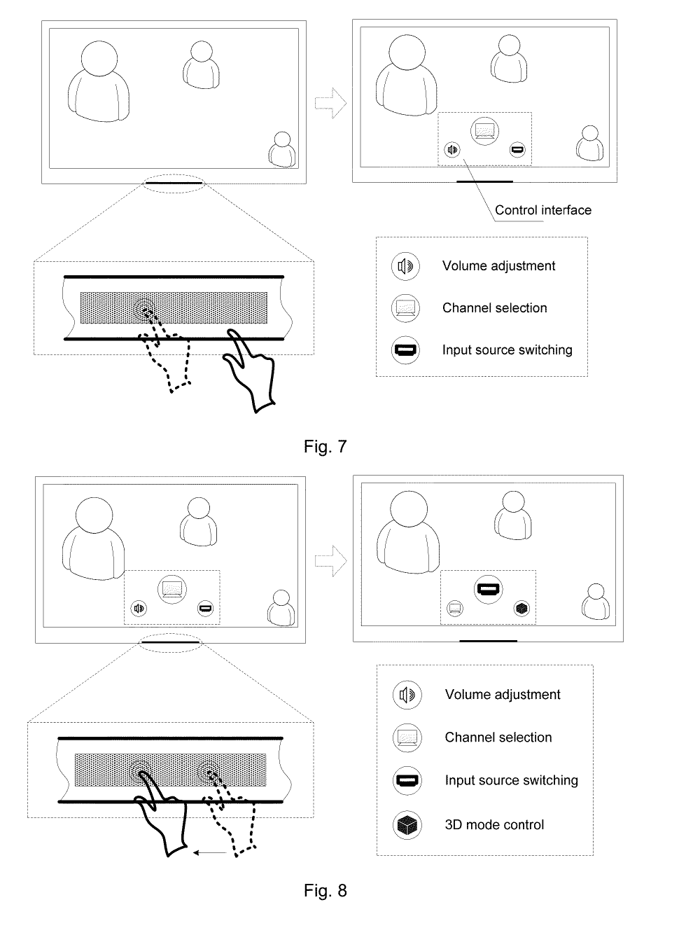

In order to minimize the effect to images and/or videos that the TV displays while displaying the control interface, and make the user's observation and operation easy, the controller 340 may control the TV to display the control interface transparently over the images and/or videos, and may only display a portion of the icons in the function list corresponding to the control interface. FIG. 7 is a diagram illustrating the control interface. Wherein, the TV may be on and may be in the digital TV program interface display mode, the controller 340 may detect and/or determine a click operation by the user on the touch pad, find that the function list corresponding to the digital TV program display mode contains 6 functions, e.g., a searching remote control function, a volume adjustment function, a channel selection function, an input source switching function, a 3D mode control function and a brightness adjustment function. The controller 340 may place the icons corresponding to these 6 functions in the above mentioned sequence, and only display 3 icons of the functions among these items at a time. for example, in FIG. 7 the controller 340 may control the TV to display only the volume adjustment function, channel selection function and input source switching function respectively from left to right on the control interface, wherein, the channel selection function which locates in the middle position may be the default selected function and its icon may be the biggest in size.

On basis of the mode shown in FIG. 7, if the user performs left or right sliding on the touch pad 320, he/she may switch the selected function. For example, FIG. 8 is a diagram showing the function switches. When the controller detects and/or determines that the user's finger is sliding toward the left on the touch pad 320, it may adjust the position of the displayed icon of each function, e.g. hide the icon of the volume adjustment function, moves the icon corresponding to the channel selection function to the left, switch the input source switching function to be the selected function and moves its icon to be displayed in the center position, and at the same time display an icon of a next function in the sequence, i.e. the icon of 3D mode control function, which may be next to the input source switching function on the right.

When the electronic device 1500 is in the waked-up mode and displays the control interface, and the touch control operation is the fourth operation, the controller 340 may carry out the control instruction corresponding to the selected function in the control interface.

When the selected function corresponds to a secondary menu, the control instruction corresponding to the function may be to instruct the electronic device 1500 to display the secondary menu of the selected function; when the selected function does not correspond to the secondary menu, the control instruction corresponding to the function may be to instruct the electronic device 1500 to conduct the selected function.

The fourth operation may be click operation. When the TV displays the control interface and the controller 340 detects and/or determines that the user's touch control operation on the touch pad is a click operation, the controller 340 may carry out the control instruction corresponding to the selected function. For example, if the currently selected is an icon of the searching remote control function, and the function does not correspond to the secondary menu, the controller 340 may control the TV to send a wireless signal to the remote control. The remote control may send out a ring tone to notify the user of its location after receiving the wireless signal. When the currently selected is an icon of the input source switching function, and the function corresponds to the input source selection menu, the controller 340 may control the TV to display the input source selection menu. The input source selection menu may include options of multiple input sources. The user may select an input source option by sliding his/her finger left and right on the touch pad 320, and click the selected option to determine the input source.

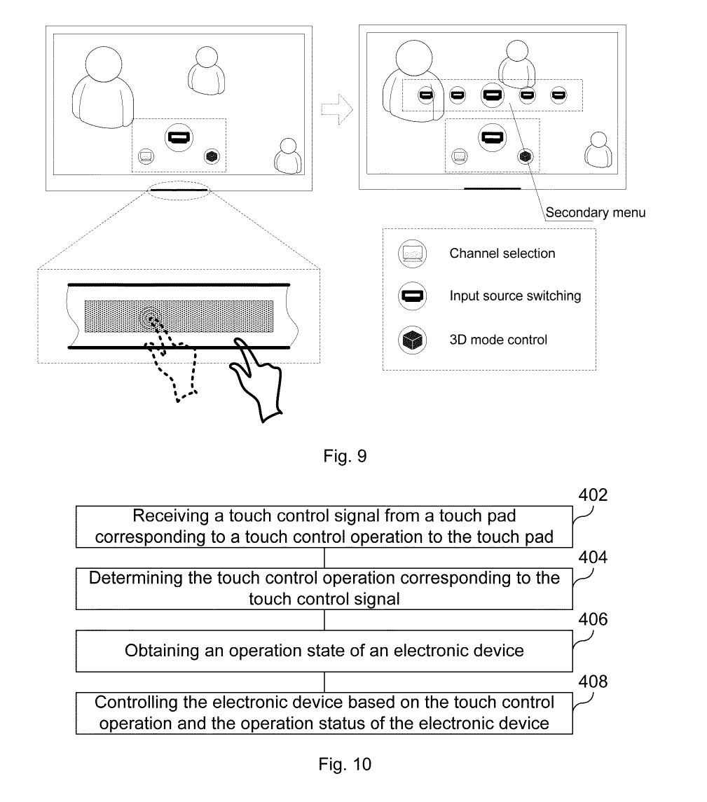

FIG. 9 is a diagram displaying the secondary menu. When the selected function on the control interface is the input source switching function, the controller 340 opens the secondary menu of the input source switching function when it detects and/or determines the user's click operation on the touch pad. The secondary menu contains icons of 5 input sources. The icon of the currently selected input source may be bigger than icons of unselected input sources and may be highlighted. The user may switch the icon of the selected input source to another icon by sliding his/her finger towards left and right over the touch pad 320. Differing from FIG. 8, the positions of the icons in the secondary menu may remain unchanged. Only the size and display effect (e.g., color, highlight, etc.) of the selected icon in the secondary menu is changed. When the user selects an icon and click the icon through the touch pad 320, the controller 340 may instruct the TV to conduct the corresponding function.

In conclusion, the touch control assembly shown in the example embodiment detects and/or determines the touch control operation on the touch pad by the signals sent by the touch pad, controls the electronic device according to the operation state of the touch control operation and the electronic device. The user may control the electronic device according to different operations in the touch pad with no need to seek and press different physical keys. The problem of related technology that the user may easily make wrong operation when using the physical keys may be solved, resulting in simplification of user operation and improved user experience.

FIG. 10 is a flow chart of a method for controlling a device according to an example embodiment. The method may be applied in the touch control assembly 100, 200, and/or 300 as shown in FIGS. 1, 2 and 4 to control the electronic device 1500 comprising the touch pad. The electronic device 1500 may be a TV or a display. The device control method may include the following operations:

In operation 402, a controller may receive a touch control signal, which may be sent by a touch pad in the touch control assembly and corresponds to the touch control operation on the touch pad;

In operation 404, the controller may analyze and determine the touch control operation corresponding to the touch control signal;

In operation 406, the controller may obtain the operation state of an electronic device;

In operation 408, the controller may control the electronic device according to the touch control operation and the operation state of the electronic device.

In conclusion, the device control method shown by the example embodiment detects and/or determines the touch control operation on the touch pad according to the touch control signal sent by the touch pad, and controls the electronic device according to the touch control operation and the state of the electronic device. The user may control the electronic device according to different operations in the touch pad with no need to seek and press different physical keys. The problem of related technology that the user may easily make wrong operation when using the physical keys may be solved, resulting in simplification of user operation and improved user experience

FIG. 11 is a flow chart of a method for controlling a device according to an example embodiment.

In operation 502, the controller may receive a touch control signal, which may be sent by the touch pad in the touch control assembly and correspond to the touch control operation on the touch pad;

For example, the touch pad may be arranged with several touch control points. Electrostatic induction occurs when the user is touching the touch control point in the touch pad by his/her finger. A current sensing signal may be generated. The touch pad generates a corresponding touch control signal according to the generated current sensing signal and sends it to the controller. The touch control signal contains the identification of the touch control point of the user's current touching location. For example, the identification of the touch control point may be the coordinate or the serial number of the touch control point.

In operation 504, the controller may analyze and determine the touch control operation corresponding to the touch control signal;

Wherein, the controller may analyze and determine the user's touch control operation on the touch pad according to the time when the touch control signal is received and the identification of the touch control point contained in the touch control signal. The touch control operation may be click operation, long press operation or slide operation, etc. The controller may carry out operation such as wake-up, standby, menu selection and control instruction according to the touch control operation and the operation state of the electronic device.

In operation 506, the controller may obtain the operation state of the electronic device;

The operation state of the electronic device may comprise wake-up, standby and display of the control interface, etc.

In operation 508, the controller may control the electronic device according to the touch control operation and the state of the electronic device.

The first operation may be a long press operation. Taking the TV for example, the controller may control to activate the TV when the TV is powered on and in standby mode, if the controller detects and/or determines that the user may be conducting a long press operation on the touch pad according to the touch control signal sent by the touch pad.

For example, FIG. 5 is a diagram showing that the user is waking up an electronic device. When the TV is in the standby mode, the controller controls the TV to be waked up when it detects and/or determines that the user's finger keeps touching on the touch pad for over 3 s.

In operation 510, the controller may turn the electronic device to the standby mode when the electronic device is in the waked-up mode and the touch control operation may be a second operation;

The second operation may also be a long press operation. The controller may control the TV to be in standby mode when the TV is waked up, if the controller detects and/or determines that the user is conducting a long press operation on the touch pad according to the touch control signal sent by the touch pad.

For example, FIG. 6 is a diagram showing that the user is turning an electronic device in to the standby mode. When the TV is in the waked-up mode, the controller controls the TV to be in the standby mode when it detects and/or determines that the user's finger keeps touching on the touch pad for over 3 s.

In operation 512, the controller may switch to an icon corresponding to a selected function in the control interface when the electronic device is in the waked-up mode and displays the control interface, and the touch control operation may be a third operation;

The control interface may include the icon corresponding to at least one function.

The third operation may be slide operation. For example, the control interface of the TV may display one or more icons, and each icon corresponds to one function. These functions may contain a searching remote control function, a volume adjustment function, a channel selection function, an input source switching function, a 3D mode control function and a brightness adjustment function, etc. When the TV displays the control interface and if the controller detects and/or determines that the user's operation on the touch pad is a slide operation, the controller may switch the icon of the selected function in the current displayed control interface. For example, the controller may switch the channel selection function to the input source switching function.

The icon corresponding to the function displayed on the control interface may include one icon corresponding to the selected function. The selected function and the unselected function may be distinguished by the display effect. For example, the selected function has the biggest size, or the selected function corresponds to colorful icon and unselected function corresponds to black and white ones, or the selected function is displayed with highlight, etc.

When the controller is switching and/or selecting the icon corresponding to the selected function in the control interface, it may also obtain the sliding direction of the slide operation, and switch the icon corresponding to the selected function according to the sliding direction. For example, the icons of the respectively function of the control interface of the TV are arranged in predetermined order. When the controller detects and/or determines that the user's operation on the touch pad is a slide operation toward right, it switches the icon of the selected function of the control interface to be the icon of the previous function. When the controller detects and/or determines that the user's operation on the touch pad is a slide operation toward left, it switches the icon of the selected function of the control interface to be the icon of the next function.

The sliding direction among the slide operation may be determined according the successively sliding touch control points in the slide operation. For example, the controller may set or obtain preset the serial number for each touch control point on the touch pad in advance. When the user's finger touches one point by sliding, the touch pad sends the touch control signal which may carry the serial number of the touch control point to the controller. The controller determines the sliding direction according to the order of the received touch control signals containing the serial number of the touch control point.

The controller may obtain the GUI display status of the electronic device, when the electronic device is in the waked-up mode and does not display the control interface. It determines the function list corresponding to the control interface according to the GUI display status, and displays a corresponding icon of at least one function according to the function list; the at least one function may be all or portion of the functions contained in the function list.

Taking TV for example of the electronic device, the TV may have different GUI display statuses, For example, the digital TV program interface display mode, the on demand interface display mode, the network interface display mode, or the game interface display mode, etc. The functions contained in the control interface corresponding to different display modes may be different. When the TV displays the control interface, for example, when the TV is waked up and does not display the control interface, if the controller in the TV detects and/or determines the user's click operation on the touch pad, it determines the TV's current display mode at first, and determines the corresponding function list according to the display mode, then displays the control interface and the corresponding icon of at least one function according to the function list.

In order to minimize the effect on the TV's display image while displaying the control interface, and make the user's observation and operation easy, the control interface may be displayed transparently over a back ground image and/or video displayed by the TV, and only a portion of the icons of the function list corresponding to the control interface may be displayed. As shown in FIG. 7, which is a diagram displaying the control interface, the TV may be waked up and may be in the digital TV program interface display mode, the controller detects and/or determines the user's click operation on the touch pad, finds and/or determines that the function list corresponding to the digital TV program display mode contains 6 functions, e.g., a searching remote control function, a volume adjustment function, a channel selection function, an input source switching function, a 3D mode control function and a brightness adjustment function. The controller displays the icons corresponding to these 6 functions according to the above mentioned sequence, and only displays 3 icons of the functions among these items at the same time. In FIG. 7, the controller controls the TV to display the volume adjustment function, channel selection function and input source switching function respectively from left to right on the control interface, wherein, the channel selection function which locates in the middle position may be the default selected function and its icon may be the biggest in size.

On basis of the state shown in FIG. 7, if the user performs left and right sliding on the touch pad, he/she may switch the selected function. For example, as shown in FIG. 8, which is a diagram showing the function switches, when the controller detects and/or determines that the user's finger may be sliding toward the left on the touch pad, the controller adjusts the position of the displayed icon of each function, e.g. hides the icon of the volume adjustment function, moves the icon corresponding to channel selection function to the left, switches the input source switching function to be the selected function and moves its icon to be displayed in the middle position, at the same time displays an icon of a function, i.e. the icon of 3D mode control function, which may be next to the input source switching function in the right.

In operation 514, the controller may carry out the control instruction corresponding to the selected function in the control interface when the electronic device is in the waked-up mode and displays the control interface, and the touch control operation is the fourth operation.

When the selected function corresponds to a secondary menu, the control instruction corresponding to the function may be the instruction used for instructing the electronic device to display the secondary menu of the selected function; when the selected function does not correspond to a secondary menu, the control instruction corresponding to the function may be the instruction to control the electronic device according to the function corresponding to the selected function.

The fourth operation may be click operation. When the TV displays the control interface and the controller detects and/or determines that the user's touch control operation on the touch pad is a click operation, the control instruction corresponding to the selected function may be carried out. For example, if the currently selected functionality icon is the icon of the searching remote control function, and the function does not correspond to a secondary menu, the controller may control the TV to send wireless signal to the remote control. The remote control rings by notification tone to notify the user of its location after the remote control receives the wireless signal; or when the currently selected function icon is an input source switching function, and the function corresponds to the input source selection menu, the controller controls the TV to display the input source selection menu. The input source selection menu may contain the selection item of multiple input sources, the user may select a corresponding item by left and right sliding in the touch pad, and determine an input source corresponding to one selection item by clicking.

As shown in FIG. 9, which is a diagram displaying the secondary menu, the selected function of the current control interface is the input source switching function. The controller enters into the secondary menu of the input source switching function when it detects and/or determines the user's click operation on the touch pad. The secondary menu contains icons of 5 input sources. The icon of the current selected input source is bigger than the icon of unselected input source and/or is highlighted. The user may switch the icon of the selected input source by left and right sliding. Different from FIG. 8, the position of the icon in the secondary menu may be unchanged, and only the size and display effect of the icon of the selected input source are changed.

In conclusion, the device control method shown in the example embodiment detects and/or determines the touch control operation on the touch pad by the signals sent by the touch pad, controls the electronic device according to the operation state of the touch control operation and the electronic device. The user may control the electronic device according to different operations in the touch pad with no need to seek and press different physical keys. The problem of related technology that the user may easily make wrong operation when using the physical keys may be solved, while simplifying the user's operation and improving the user's experiences.

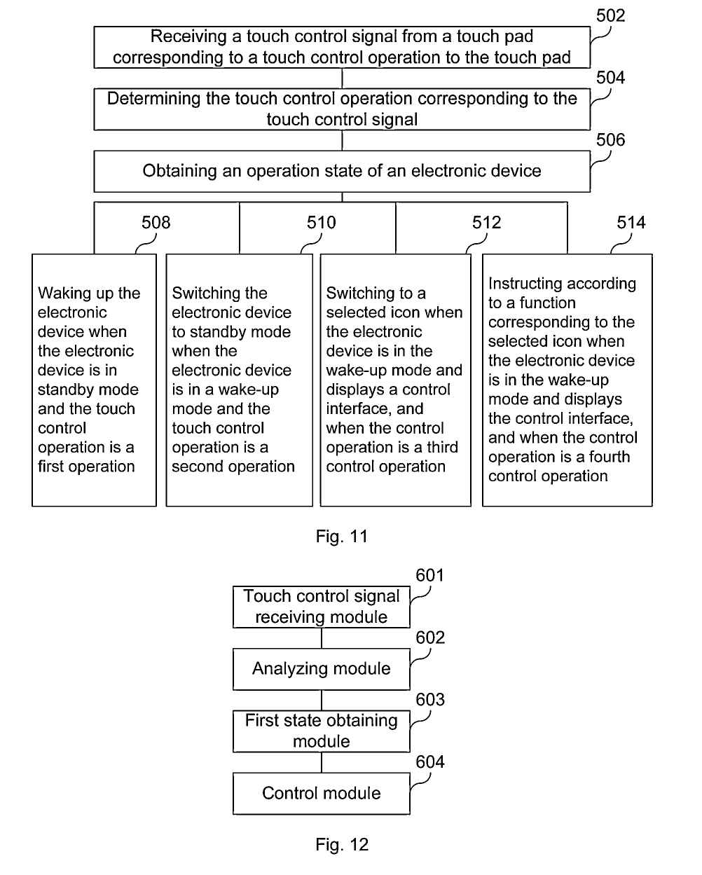

FIG. 12 is a block diagram illustrating a controller according to an example embodiment. The controller may be applied in the touch control assembly as shown in FIGS. 1, 2 & 4 to control the electronic device comprising the touch pad. The electronic device may be a TV or a display. The controller may include: a touch control signal receiving module 601, an analyzing and interpreting module 602, a first state obtaining module 603 and a control module 604.

The touch control signal receiving module 601 may be configured to receive a touch control signal, which may be sent by the touch pad in the touch control assembly and corresponds to the touch control operation on the touch pad;

The analyzing and interpreting module 602 may be configured to analyze and determine the touch control operation according to the touch control signal;

The first state obtaining module 603 may be configured to obtain the operation state of the electronic device;

The control module 604 may be configured to control the electronic device according to the touch control operation and the state of the electronic device.

In conclusion, the controller shown by the example embodiment detects and/or determines the touch control operation on the touch pad according to the touch control signal sent by the touch pad, and controls the electronic device according to the touch control operation and the state of the electronic device. The user may control the electronic device according to different operations in the touch pad with no need to seek and press different physical keys. The problem of related technology that the user may easily make wrong operation when using the physical keys may be solved, while simplifying the user's operation and improving the user's experiences.

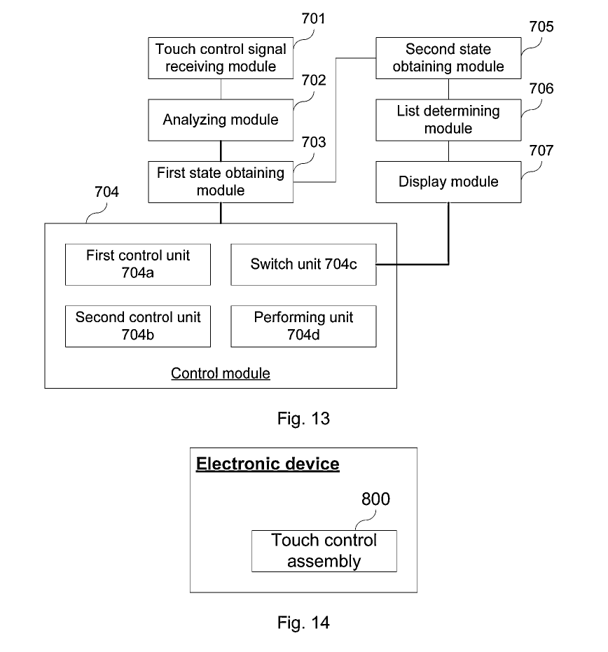

FIG. 13 is a block diagram illustrating a controller according to another example embodiment. The controller may be applied in the touch control assembly as shown in FIGS. 1, 2 & 4 to control the electronic device comprising the touch pad. The electronic device may be a TV or a display. The controller may include: a touch control signal receiving module 701, a analyzing and interpreting module 702, a first state obtaining module 703 and a control module 704;

The touch control signal receiving module 701 may be configured to receive a touch control signal, which may be sent by the touch pad in the touch control assembly and corresponds to the touch control operation on the touch pad;

The analyzing and interpreting module 702 may be configured to analyze and interpret the touch control operation according to the touch control signal;

The first state obtaining module 703 may be configured to obtain the operation state of the electronic device;

The control module 704 may be configured to control the electronic device according to the touch control operation and the state of the electronic device.

The control module 704 may include a first control unit 704a and a second control unit 704b;

The first control unit 704a may be configured to control the electronic device to be waked up when the electronic device is in the standby mode and the touch control operation is the first operation;

The second control unit 704b may be configured to control the electronic device to be standby when the electronic device is in the waked-up mode and the touch control operation is the second operation.

The control module 704 may include a switch unit 704c;

The switch unit 704c may be configured to switch an icon corresponding to a selected function in the control interface when the electronic device displays the control interface, and the touch control operation is a third operation; the control interface may include the icon corresponding to at least one function.

The control module further may include: a second state obtaining module 705, a list determining module 706 and a display module 707;

The second state obtaining module 705 may be configured to obtain the GUI display status of the electronic device when the electronic device is in the waked-up mode and does not display the control interface;

The list determining module 706 may be configured to determine the function list corresponding to the control interface according to the GUI display status;

The display module 707 may be configured to display the control interface according to the function list, and the at least one function contained in the control interface may be all or portion of the function items contained in the function list.

The control module 704 may include a performing unit 704d;

The performing unit 704d may be configured to perform the control instruction corresponding to the selected function in the control interface, when the electronic device displays the control interface and the touch control operation is the fourth operation.

In conclusion, the controller shown by the example embodiment detects and/or determines the touch control operation on the touch pad according to the touch control signal sent by the touch pad, and controls the electronic device according to the touch control operation and the state of the electronic device. The user may control the electronic device according to different operations in the touch pad with no need to seek and press different physical keys. The problem of related technology that the user may easily make wrong operation when using the physical keys may be solved, while simplifying the user's operation and improving the user's experiences.

FIG. 14 may be a block diagram illustrating an electronic device according to an example embodiment. The electronic device may be a TV. The electronic device may comprise: at least one touch control assembly 800 shown by anyone of FIG. 1, 2 or 4.

In conclusion, the electronic device shown by the example embodiment detects and/or determines the touch control operation on the touch pad according to the touch control signal sent by the touch pad, and controls the electronic device according to the touch control operation and the state of the electronic device. The user may control the electronic device according to different operations in the touch pad with no need to seek and press different physical keys. The problem of related technology that the user may easily make wrong operation when using the physical keys may be solved while simplifying the user's operation and improving the user's experiences.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes may be made without departing from the scope thereof. It may be intended that the scope of the invention should only be limited by the appended claims.

1. A touch control assembly for controlling a television, comprising:
a touch pad to detect a touch control operation to conducted thereon;
a controller in the television in communication with the touch pad to receive from the touch pad a touch control signal corresponding to the touch control operation,
determine the touch control operation based on the touch control signal;
obtain an operation state of the television, and
control the television according to the touch control operation and the operation state of the television.

2. The touch control assembly according to claim 1, wherein when the operation state of the television is a standby mode, and the touch control operation comprises a first operation, the controlling of the television comprises waking up the television.

3. The touch control assembly according to claim 1, wherein when the operation state of the television is a waked-up mode, and the touch control operation is a second operation, the controlling of the television comprises turning the television to a standby mode.

4. The touch control assembly according to claim 1, wherein the television displays a control interface comprising at least one icon thereon, each of the at least one icon corresponds with a function of the television,
when the operation state of the television is a waked-up mode and the touch control operation is a third operation the controlling of the television comprises selecting an icon of the at least one icon corresponding to a function selected by the touch control operation.

5. The touch control assembly according to claim 4, wherein the controller is further configured to:
receive a fourth operation from the touch pad, and
send an instruction to the television to conduct the selected function in response to the fourth operation.

6. The touch control assembly according to claim 1, wherein when the operation state of the television is the wake-up mode and the television does not display a control interface, the controller controls the television to:
obtain a Graphical User Interface display status of the television,
determine a list of functions corresponding to the control interface according to the GUI display status, and
display an icon corresponding to at least one function of the list of functions.

7. The touch control assembly according to claim 1, wherein the touch control operation comprises one of:
a first operation comprising touching the touch pad longer than a predetermined period of time;
a second operation comprising touching the touch pad longer than a predetermined period of time;
a third operation comprising a slide operation over the touch pad; and
a fourth operation comprising a click operation over the touch pad.

8. A method for controlling a television, comprising:
providing a television comprising a controller, the controller is configured to communicate with a touch pad;
receiving, by a controller, a touch control signal corresponding to a touch control operation conducted on the touch pad;
determining, by the controller, the touch control operation based on the touch control signal;
obtaining, by the controller, an operation state of the television; and
controlling, by the controller, the television according to the touch control operation and the operation state of the television.

9. The method according to claim 8, wherein when the operation state of the television is a standby mode, and the touch control operation comprises a first operation, the controlling of the television comprises waking up the television.

10. The method according to claim 8, wherein when the operation state of the television is a waked-up mode, and the touch control operation is a second operation, the controlling of the television comprises turning the television to a standby mode.

11. The method according to claim 8, wherein the television displays a control interface comprising at least one icon thereon, each of the at least one icon corresponds with a function of the television,
when the operation state of the television is a waked-up mode and the touch control operation is a third operation, the controlling of the television comprises selecting an icon of the at least one icon corresponding to a function selected by the touch control operation.

12. The method according to claim 11, further comprising:
receiving, by the controller, a fourth operation from the touch pad, and
sending, by the controller, an instruction to the television to conduct the selected function in response to the fourth operation.

13. The method according to claim 8, wherein when the operation state of the television is the wake-up mode and does not display a control interface, the controlling of the television further comprises
obtaining a Graphical User Interface display status of the television,
determining a list of functions corresponding to the control interface according to the GUI display status, and
display an icon corresponding to at least one function of the list of functions.

14. The method according to claim 8, wherein the touch control operation comprises one of:
a first operation comprising touching the touch pad longer than a predetermined period of time;
a second operation comprising touching the touch pad longer than a predetermined period of time;
a third operation comprising a slide operation over the touch pad; and
a fourth operation comprising a click operation over the touch pad.

15. A television, comprising:
a touch sensing area on a surface of the television to detect a touch control operation on the touch sensing area;
a controller in the television in communication with the touch sensing area to
receive from the touch sensing area a touch control signal corresponding to the touch control operation,
determine the touch control operation based on the touch control signal,
obtain an operation state of the television, and
direct the television to conduct an operation according to the touch control operation and the operation state.

16. The television according to claim 15, wherein when the operation state of the television is a standby mode, and the touch control operation comprises a first operation, the operation of the television comprises waking up the television.
wherein when the operation state of the television is a waked-up mode, and the touch control operation is a second operation, the operation of the television comprises turning the television to a standby mode.

17. The television according to claim 15, wherein the television displays a control interface comprising at least one icon thereon, each of the at least one icon corresponds with a function of the television,
when the operation state of the television is a waked-up mode and the touch control operation is a third operation the operation of the television comprises selecting an icon of the at least one icon corresponding to a function selected by the touch control operation.

18. The television according to claim 17, wherein the controller is further configured to:
receive a fourth operation from the touch pad, and
direct the television to conduct the selected function in response to the fourth operation.

19. The television according to claim 15, wherein when the operation state of the television is the wake-up mode and the television does not display a control interface, the controller directs the television to:
obtain a Graphical User Interface display status of the television,
determine a list of functions corresponding to the control interface according to the GUI display status, and
display an icon corresponding to a function of the list of functions.

20. The television according to claim 15, wherein the touch control operation comprises one of:
a first operation comprising touching the touch pad longer than a predetermined period of time;
a second operation comprising touching the touch pad longer than a predetermined period of time;
a third operation comprising a slide operation over the touch pad; and
a fourth operation comprising a click operation over the touch pad.
